(19) United States
(12) Patent Application Publication
(10) Pub. No.: US 2024/0112215 A1
(43) Pub. Date: Apr. 4, 2024

(54) SYSTEMS AND METHODS FOR DISTRIBUTING REWARDS BASED ON THE PERFORMANCE OF REAL-WORLD ACTIONS IN ASSOCIATION WITH MULTIMEDIA CONTENT

(71) Applicant: Discovery Communications, LLC, New York, NY (US)

(72) Inventors: Brian F. ROBERTS, Dallas, TX (US); Chad PELTOLA, Fairfield, CT (US); Jill MULLIGAN, Greenwich, CT (US); Charles ROBERTSON, Seattle, WA (US); Kyle JACKSON, New York, NY (US); Enrique FLORENDO, Westlake Village, CO (US)

(21) Appl. No.: 17/936,636

(22) Filed: Sep. 29, 2022

(51) Int. Cl. G06Q 30/02

(52) U.S. Cl. CPC G06Q 30/0217; G06Q 30/0205

(57) ABSTRACT

Systems and methods for distributing rewards based on user actions performed in association with multimedia content are disclosed. One computer-implemented method may include: receiving, at the server, an indication of a real-world action performed by a user; identifying, by the server, that the real-world action corresponds to a rewards-based action performed in association with an article of multimedia content present on a media-streaming platform, wherein the rewards-based action at least corresponds to visitation to a geographic location associated with an aspect of the article of multimedia content; determining, by the server, whether performance of the rewards-based action necessitates distribution of a reward to the user, ascertaining, subsequent to determining that performance of the rewards-based action does necessitate distribution of the reward to the user, a type of the reward; and distributing, based on the ascertaining, the reward of the ascertained type to the user. Other aspects are described and claimed.

### TECHNICAL FIELD

Various embodiments of the present disclosure relate generally to the field of rewards distribution, and, more particularly, to the distribution of rewards based on the detection of real-world actions of a user in relation to articles of multimedia content.

### BACKGROUND

Subscription-based video streaming platforms provide individuals with a vast array of multimedia content (e.g., movies, television shows, documentaries, etc.) to consume on their information handling devices, e.g., smart phones, tablets, laptops and/or personal computers, televisions, and the like. Many individuals become invested in their favorite articles of multimedia content and may desire to experience additional engagement with certain aspects of the multimedia content that go beyond conventional viewership. The present disclosure is accordingly directed to distributing various rewards to individuals that pursue these additional engagements.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for enabling dynamic notification provision based at least in part on knowledge of a user's geographic location.

In one aspect, a computer-implemented method for distributing rewards based on user actions performed in association with multimedia content using a server in network communication with at least one database is disclosed, the method comprising operations including: receiving, at the server, an indication of a real-world action performed by a user; identifying, by the server, that the real-world action corresponds to a rewards-based action performed in association with an article of multimedia content present on a media-streaming platform, wherein the rewards-based action at least corresponds to visitation to a geographic location associated with an aspect of the article of multimedia content; determining, by the server, whether performance of the rewards-based action necessitates distribution of a reward to the user, ascertaining, subsequent to determining that performance of the rewards-based action does necessitate distribution of the reward to the user, a type of the reward; and distributing, based on the ascertaining, the reward of the ascertained type to the user.

In another aspect, a system for distributing rewards based on user actions performed in association with multimedia content is disclosed, the system comprising: at least on processor; at least one database; and a server in network communication with the at least one database, the server configured to perform operations including: receiving, at the server, an indication of a real-world action performed by a user; identifying, by the server, that the real-world action corresponds to a rewards-based action performed in association with an article of multimedia content present on a media-streaming platform, wherein the rewards-based action at least corresponds to visitation to a geographic location associated with an aspect of the article of multimedia content; determining, by the server, whether performance of the rewards-based action necessitates distribution of a reward to the user, ascertaining, subsequent to determining that performance of the rewards-based action does necessitate distribution of the reward to the user, a type of the reward; and distributing, based on the ascertaining, the reward of the ascertained type to the user.

In yet another aspect, a non-transitory computer-readable medium storing computer-executable instructions which, when executed by a server in network communication with at least one database, cause the server to perform operations comprising: receiving, at the server, an indication of a real-world action performed by a user; identifying, by the server, that the real-world action corresponds to a rewards-based action performed in association with an article of multimedia content present on a media-streaming platform, wherein the rewards-based action at least corresponds to visitation to a geographic location associated with an aspect of the article of multimedia content; determining, by the server, whether performance of the rewards-based action necessitates distribution of a reward to the user, ascertaining, subsequent to determining that performance of the rewards-based action does necessitate distribution of the reward to the user, a type of the reward; and distributing, based on the ascertaining, the reward of the ascertained type to the user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts an exemplary flowchart of a method of distributing a reward subsequent to detection that a user has performed a rewards-based action in associated with an article of multimedia content, according to one or more embodiments.

FIG. 3 depicts an exemplary GUI of a media-streaming platform, according to one or more embodiments

FIG. 4(A-B) depicts an exemplary GUI of a media-streaming platform, according to one or more embodiments.

FIG. 5(A-B) depicts an exemplary GUI of a media-streaming platform, according to one or more embodiments.

FIG. 6 depicts an exemplary push notification, according to one or more embodiments.

FIG. 7 depicts an exemplary push notification, according to one or more embodiments.

FIG. 8 depicts an exemplary computing server, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “user”, “subscriber,” and the like generally encompasses consumers who are subscribed to a streaming service (e.g., streaming platform) associated with the system described herein. The term “streaming service” (e.g., streaming platform) may refer to subscription-based video-on-demand (SVoD) services such as television shows, films, documentaries, and the like. The term “user” may be used interchangeably with “user profile,” “profile,” and the like throughout this application. The phrase “registered with” may be used interchangeably with “subscribed to” and the like throughout this application. The phrase “multimedia content” may be used interchangeably with “multimedia content item”, “article of multimedia content”, and the like throughout this application.

In the following description, embodiments will be described with reference to the accompanying drawings. As will be discussed in more detail below, in various embodiments, systems and methods for providing dynamic, location-based notifications to a user are described.

Individuals may be interested in engaging with their favorite articles of multimedia content (e.g., shows, movies, etc.) in a deeper way than just viewing them on their devices. For instance, individuals may want to visit and see the real-world locations and/or things (e.g., cities, towns, structures, objects, establishments, etc.) featured in their favorite shows or movies. Conventionally, this additional engagement may go unnoticed and unrewarded. More particularly, no real incentive exists, other than inherent user interest, for individuals to expend time, effort, and resources to visit locations affiliated with their favorite articles of multimedia content.

To address the above-noted problems, the present disclosure describes a system that may distribute various types of rewards to users that complete certain real-world actions in association with their favorite articles of multimedia content. More particularly, the system may receive an indication of a real-world action performed by a user and then identify that the real-world action corresponds to a rewards-based action performed in association with an article of multimedia content present on a media-streaming platform. Non-limiting examples of rewards-based actions may include: visiting a location associated with an article of multimedia content, capturing a picture at the location of a predetermined object, scanning a QR code at the location, and the like. The system may then determine whether performance of the rewards-based action necessitates distribution of a reward to a user. For instance, some rewards may be distributed after performance of a single rewards-based action whereas other rewards may require performance of a multitude of the same or different types of rewards-based actions. Subsequent to determining that performance of the rewards-based action does necessitate distribution of a reward, the system may ascertain the type of reward (e.g., a type of currency, an unlockable feature, a raffle entry, a digital avatar feature addition, etc.) and thereafter distribute that reward type to the user.

Although the subject matter disclosed herein is generally described with reference to a user's favorite articles of multimedia content, it is important to note that these designations are not limiting. More particularly, some or all of the embodiments that are subsequently described may be applicable to other areas of user interest (e.g., art, books, nature, etc.).

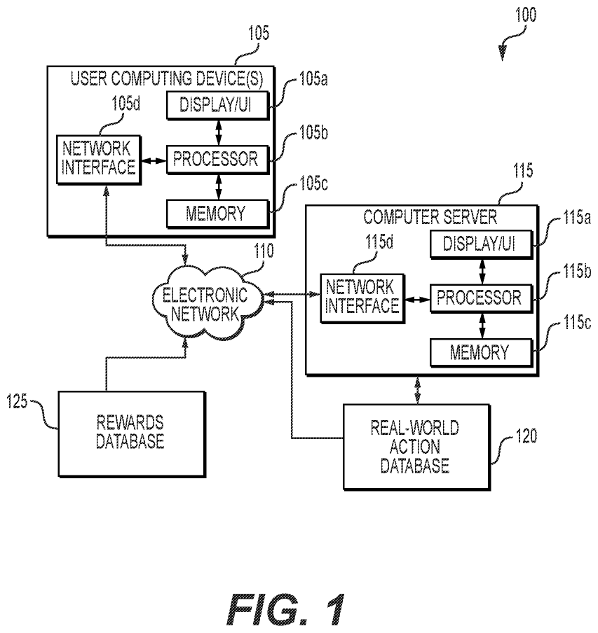

FIG. 1 depicts an exemplary block diagram of a system environment 100 configured to distribute rewards to users, according to one or more embodiments of the present disclosure. The system environment 100 may include a user computing device 105 operated by a user, an electronic network 110, a computer server 115, a real-world action database 120, and a rewards database 125.

The user computing device 105, the server 115, the real-world action database 120 and/or the rewards databases 125 may be connected via the network 110, using one or more standard communication protocols. The server 115 may be configured to receive data over the network 110 from the user computing device 105, including, but not limited to, device-based location data, device transmissions (e.g., captured pictures/videos, indications of scanned items, etc.), and other type of real-world action data. “Real-world action data” may include data received from the user computing device 105 that provides indications of real-world actions performed by a user. The real-world action data may be stored in the real-world action database 120, and may include indications of all the identified real-world actions performed by the user. The server 115 may store the real-world action data received over the network 110 in the multimedia content preference database 120.

In one or more embodiments, the computer server 115, the real-world action database 120, and/or the rewards database may be one server computer device and a single database, respectively. Alternatively, in one or more embodiments, the server 115 may be a server cluster, or any other collection or network of a plurality of computer servers. The real-world action database 120 and/or the rewards database 125 also each may be a collection of a plurality of interconnected databases. The server 115 and the real-world action database 120 and/or the rewards database 125 may be components of one server system. Additionally, or alternatively, the server 115 and the real-world action database 120 and/or the rewards database 125 may be components of different server systems, with the network 110 serving as the communication channel between them. The computer server 115, the real-world action database 120, and/or the rewards database 125 may be associated with an entity 130, such as a subscription-based streaming service provider (not shown). In some embodiments, the computer server 115, the real-world action database 120, and/or the rewards database 125 may collectively be referred to as an entity system.

As shown in FIG. 1, the computer server 115 may be in communication with the user device 105 to transmit and receive data, messages, and/or instructions from each other across the network 110. The user device 105 may be associated with users who are subscribed to the entity 130. The network 110 may comprise one or more networks that connect devices and/or components of environment 100 to allow communication between the user device 105, the computer server 115, and other associated components. For example, the network 110 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of environment 100. In some embodiments, the network 110 may be implemented using cell and/or pager networks, satellite, licensed radio, or a combination of licensed and unlicensed radio. The network 110 may be associated with a cloud platform that stores data and information related to methods disclosed herein.

The user computing device 105 may include a display/user interface (UI) 105A, a processor 105B, a memory 105C, and/or a network interface 105D. The user computing device 105 may be a personal computer (PC), a tablet PC, a set-top box (STB), a streaming device (e.g., Apple TV®, Amazon Fire®, Roku® player, Google Chromecast®), a television (TV), a smart TV, a gaming console, a personal digital assistant (PDA), a mobile device, a palmtop computer, a laptop computer, a desktop computer, etc. The user computing device 105 may execute, by the processor 105B, an operating system (O/S) and at least one application (each stored in memory 105C). The application may be a browser program or a mobile application program (which may also be a browser program in a mobile O/S). The application may be able to generate and/or distribute rewards of various types to the user, based on instructions/information received from the server 115. In some embodiments, the application may generate and/or distribute rewards based on instructions/information stored in the memory 105C. Indications of rewards distribution may manifest as notifications provided on the application GUI and may be executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the network 110. The processor 105B, while executing the application, may receive user inputs from the display/UI 105A, and perform actions or functions in accordance with the application or other related applications.

The computer server 115 may include a display/UI 115A, a processor 115B, a memory 115C, and/or a network interface 115D. The server 115 may be a computer, system of computers (e.g., rack server(s)), and/or or a cloud service computer system. The server 115 may execute, by the processor 115B, an operating system (O/S) and at least one instance of a server program (each stored in memory 115C). The server 115 may store or have access to information from real-world action database 120 and rewards database 125. The display/UI 115A may be a touch screen or a display with other input systems (e.g., mouse, keyboard, etc.) for an operator of the server 115 to control the functions of the server 115 (e.g., update the server program and/or the server information). The network interface 115D may be a TCP/IP network interface for, e.g., Ethernet or wireless communications with the network 110.

As described above, the computer server 115 may store data associated with users subscribed to a streaming service platform associated with the computer server 115. For instance, the computer sever 115 may store user profiles generated by the computer server 115 for the user. In some embodiments, the information described above, including the real-world action data, the rewards data, and any additional data received from user computing device 105, may be stored in a plurality of user profiles. Each user profile may correspond to a specific user in communication with the server 115. In an embodiment, a user may have multiple user computing devices 105 registered with the server 115 based on the user's viewing habits and/or preferences. For example, one user may register a personal laptop, a smart TV, and a mobile device with the server 115. Information associated with registered user computing device(s) 105 and the user's viewing habits and/or viewing preferences may all be stored within the user's user profile.

In some embodiments, each user profile may also include information associated with a respective user and their user computing device(s) 105 (e.g., a device identifier, device type), the user's name, a username or a nickname provided by the user for the user profile, content viewing preferences provided by the user, recommendations provided to the user by the computer server 115, the user's past viewing activity, IP addresses and locations (as well as accompanying dates and times) from where the user has logged in from, and/or user analytics generated by the server 115. In these embodiments, the user profile may be updated to reflect a corresponding user's recent activities and locations.

In the system environment 100, the computer server 115, in association with a multimedia streaming platform, may retrieve multimedia content requested by users from one or more content delivery databases 135 (not shown) to enable requested content to be streamed by users on the user computing device 105. The content delivery databases 135 may store volumes of multimedia content items, including, for example, video series, movies, documentaries, and additional programming content that may be streamed by users 102 on the user computing devices 105. In some embodiments, the content delivery databases 135 may be maintained by third party content providers. In other embodiments, the content delivery databases 135 may be maintained by the server 115 and/or additional servers associated with the server 115. In an embodiment, the computer server 115 may analyze the articles of multimedia content stored in the content delivery database(s) 125 in order to glean various aspects associated with those articles (e.g., filming location, structures featured in the article, characters/actors/individuals featured in the articles, etc.).

In some embodiments, the computer server 115 may also store additional data received from user computing device 105, including real time and/or near real time location data (e.g., GPS data) of the user computing device 105. Based on knowledge of this location data, the computer server 115 may store and/or access information in the real-world action database 120 and/or the rewards database 125 to identify whether visitation to a particular geographic location is associated with a rewards-based action.

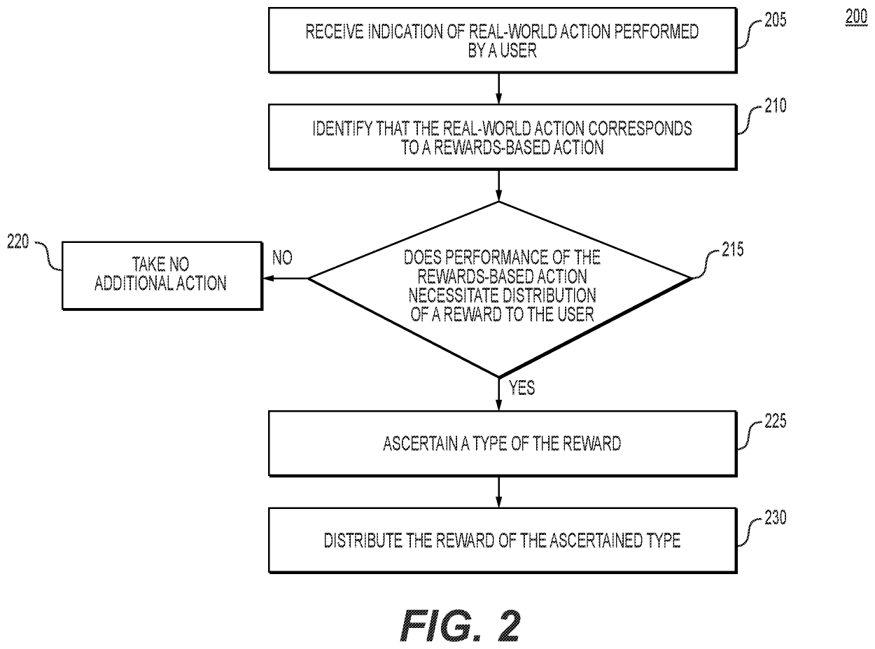

FIG. 2 depicts an exemplary process flow 200 for distributing rewards to users based on performance of certain user actions in connection with various articles of multimedia content, according to one or more embodiments of the present disclosure. The exemplary process flow 200 may be implemented by system environment 100, which includes user computing device 105 associated with a user, computer server 115, real-world action database 120, and rewards database 125 (all shown in FIG. 1).

At step 205, an indication of a real-world action performed by a user may be received at the computer server 115. In the context of this application, a real-world action may be virtually any action that is detectable by the computer server 115. For instance, a real-world action may correspond to the movement of the user computing device 105 in a predetermined manner, the visitation to a geographic location, the taking of an image/video of an object, the scanning of an object, and the like. In an embodiment, the computer server 115 may be detect the foregoing types of action via data received from one or more sensors resident on the user computing device 105. Additionally or alternatively, the computer server 115 may receive indications of these actions from other devices associated with the user computer device 105 and/or the computer server 115. For instance, if the user computing device 105 corresponded to a user's smart phone primary device (e.g., a smart phone, etc.), then the computer server 115 may also receive indications of real-world action data (e.g., user location data) from a user's secondary device (e.g., the user's smart watch).

At step 210, the computer sever 115 may identify that the real-world action corresponds to a rewards-based action. In an embodiment, a rewards-based action may be a predetermined type of action that is performed in association with an article of multimedia content. Non-limiting examples of rewards-based actions may include: visiting one or more locations associated with an article of multimedia content, capturing a picture of a predetermined object or scene, scanning a QR code resident at the location, and the like. In an embodiment, the real-world action database 120 may contain a listing of all known rewards-based actions. In an embodiment, the listing of rewards-based actions may be updated over time to include new rewards-based actions and/or to remove previously recognized rewards-based actions. An embodiment may determine whether an identified real-world action corresponds to a rewards-based action by, for example, comparing the real-world action against the listing of recognized rewards-based actions in the real-world action database 120 to determine if a match exists.

One example of a rewards-based action that is featured throughout this disclosure corresponds to the identification that a user has visited a predetermined geographic location associated with an aspect of an article of multimedia content. In an embodiment, the aspect may correspond to at least one of a place, structure, and/or object that was featured or mentioned in the article of multimedia media content or that the article of multimedia content was filmed in or at. In an embodiment, an indication of a user's geographic location may be received at the computer server 115. In the context of this application, the user's geographic location may correspond to virtually any physical position located in the real world. In an embodiment, the geographic location of the user may be deduced from location data associated with a user's computing device 105. More particularly, the computer server 115 may assume that the user's geographic position is substantially equivalent to the geographic position of their computing device 105. In an embodiment, geographic location data may be received from the computing device 105 (e.g., substantially continuously, at predetermined intervals, etc.), which may be derived from one or more location-aware technologies including, but not limited to, GPS, Wi-Fi triangulation, Enhanced Observed time Difference (E-OTD), and the like. Additionally or alternatively, in another embodiment, the geographic location of the user may be deduced from receipt of location-based context data associated with the user. More particularly, the computer server 115, given appropriate permissions, may be capable of accessing one or more of a user's calendar data (e.g., containing stored indications of designated locations a user will be located), communication data (e.g., emails, SMS messages, online chat data, etc.), and/or social media data (e.g., status updates, public posts, etc.).

In an embodiment, each article of multimedia content may be associated with a dedicated set of rewards-based actions. In an embodiment, the rewards-based actions in each set may correspond to the content and/or theme of the article of multimedia content. For example, a rewards-based action for a cooking show may require a user to take a picture of themselves cooking a predetermined meal type whereas a rewards-based action for a travel show may require the user to visit a predetermined location. In an embodiment, each set of rewards-based actions may be stored in the real-world action database 120.

At step 215, the computer server 115 may determine whether performance of the rewards-based action necessitates distribution of a reward to the user. In the context of this application, a reward may take a variety of different forms. For instance, the reward may correspond to a currency (e.g., a monetary currency, a gift card currency, a type of cryptocurrency, etc.), an unlockable feature on the media-streaming platform (e.g., an exclusive article of multimedia content, a digital badge, an ability to perform an exclusive action on the media-streaming platform (e.g., provide a suggestion to a producer of a show, converse with an actor via live stream, moderate a chat, etc.), and the like), an entry ticket into a raffle, a feature addition onto a digital avatar, and other types of rewards not explicitly listed here.

In an embodiment, certain rewards may only require performance of a single rewards-based action. For instance, responsive to identifying that a user has visited the location where an episode of a show was filmed, the computer server 115 may determine that a rewards distribution threshold has been achieved and that the user is deserving of a reward. Alternatively, in another embodiment, other rewards (i.e., “multi-action rewards”) may require performance of two or more rewards-based actions prior to rewards distribution. For example, certain rewards may require an individual to visit a predetermined number of unique geographic locations associated with one or more articles of multimedia content. In an embodiment, the two or more rewards-based actions may be rewards-based actions of the same action type (e.g., two or more geographic location visitation actions, etc.) or, alternatively, may be a combination of different action types (e.g., a first action may be a geographic location visitation action whereas a second action may be a scanning action of a predetermined object, etc.). In an embodiment, certain multi-action rewards may require the two or more rewards-based actions to be performed in a predetermined and/or within a predetermined time frame (e.g., all of the necessary rewards-based actions need to be completed within a day, a week, a month, etc.).

Responsive to determining, at step 215, that the performance of the rewards-based action does not necessitate distribution of a reward to the user, then the computer server 115 may, at step 220, take no additional action. Alternatively, the computer server 115 may transmit instructions to the user computing device 105 to display a notification that the rewards-based action was recognized but that one or more other rewards-based actions need to be completed in order for a reward to be distributed. Conversely, responsive to determining, at step 215, that the performance of the rewards-based action does necessitate distribution of a reward to the user, then the computer server 115 may ascertain, at step 225, a type of reward to distribute to the user.

In an embodiment, the ascertainment of the type of reward to distribute to the user may be based on a predetermined ruleset. For instance, in an embodiment, each article of multimedia content may have an associated ruleset (e.g., stored in the rewards database 125, etc.) that dictates the type of rewards that may be distributed to users in response to performance of rewards-based actions in association with that article of multimedia content. As an example, a ruleset may dictate that all rewards distributed in association with a particular cooking show are gift cards. Additionally or alternatively, the ruleset may dictate that the type of rewards associated with each article of multimedia content may adjust periodically (e.g., according to a rewards type schedule, etc.). For instance, all rewards in the month of August may be raffle prizes whereas all rewards earned in the month of September may be unlockable features. Additionally or alternatively, the ruleset may dictate that the type of rewards distributed may be based on the number and/or type of rewards-based action performed. For instance, traveling to a predetermined location may unlock a digital badge, taking a photo of a predetermined object at the predetermined location may unlock a feature, sharing the photo on a social media feed may award the user with monetary currency, etc. Additionally or alternatively, the ruleset may dictate that the type of reward distributed may be based upon user choice. More particularly, the computer server 115 may transmit instructions to the user computing device 105 to provide a list of available reward types that a user may select from.

In an embodiment, a value of the ascertained reward type may be determined. In one embodiment, the value of the reward may be binary in nature with respect to the performance of the rewards-based action and may remain static in value. More particularly, performance of the threshold number and/or types of rewards-based actions enables a user to receive a reward of a fixed value. Alternatively, in other embodiments, the value of the reward may be based on the type, number, and/or nature of the rewards-based action. For example, the value of a reward may be greater for a user that travels a further distance to visit a geographic location associated with an article of multimedia content than for another user that travels a shorter distance to the same geographic location. In another example, the value of a reward for user A may be greater than the value of the reward for user B if user A performs a predetermined set of rewards-based actions faster than user B.

At step 230, the computer server 115 may distribute the reward of the ascertained type to the user. In an embodiment the method of reward distribution may be based on the type of reward. For instance, currency may be distributed to a designated currency holding location (e.g., a bank account, a digital cryptocurrency wallet, a gift card balance, etc.), unlocked features may be transmitted to and/or may be enabled for a user profile of the user on the media-streaming platform, raffle tickets may be attributed to a user profile of the user on the media-streaming platform, options to update a digital avatar may be added to a user profile, and the like.

In an embodiment, individuals that perform rewards-based actions prior to being subscribed to a relevant media-streaming platform may be able to later recoup their rewards once they establish a registered account. For instance, a rewards-based action may require an individual to scan a QR code at a predetermined location. Upon scanning the QR code, the computer server 115 may determine whether the individual is a registered user of the media-streaming platform. Responsive to determining that individual is not a registered user, the computer server 115 may transmit instructions to the user computer device 105 to present an account activation option for the media-streaming platform to the user. Upon detecting that the user has established a user profile subsequent to interaction with the account activation option, the computer server 115 may transmit to the user profile a deferred link to retrieve the reward associated with the rewards-based action of scanning the QR code.

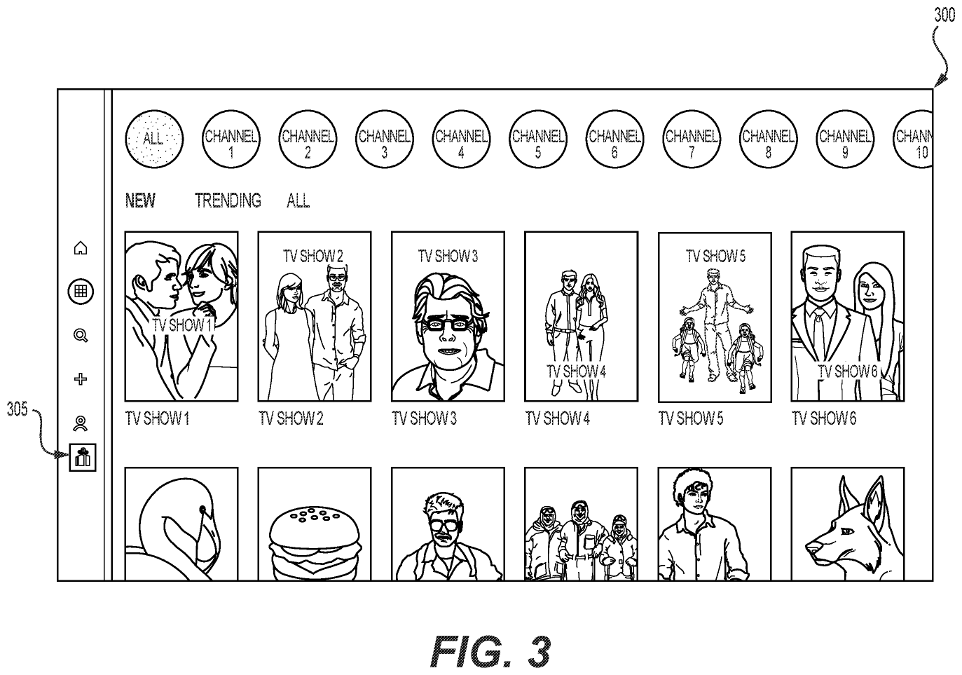

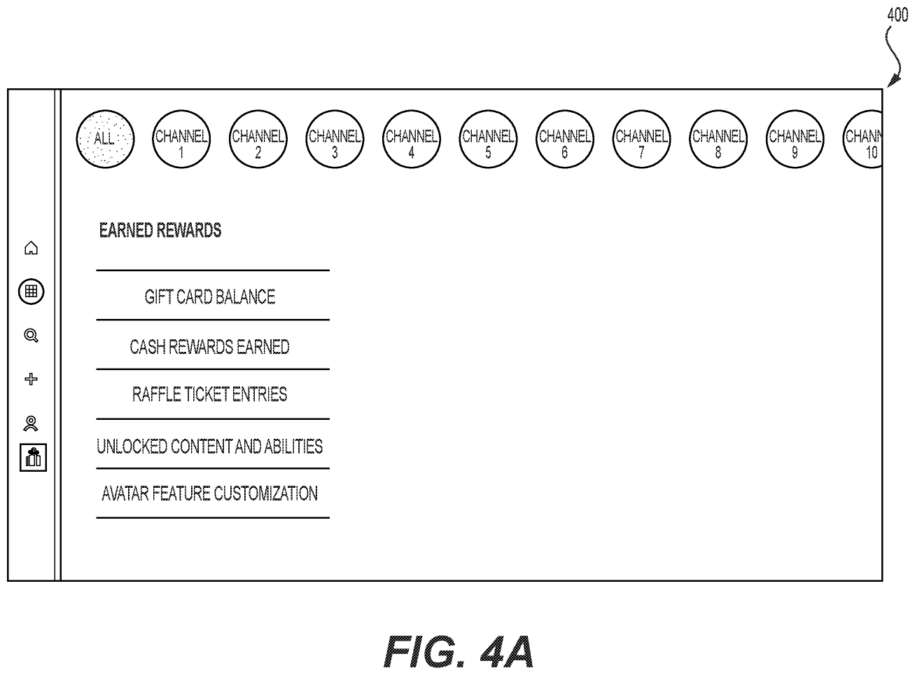

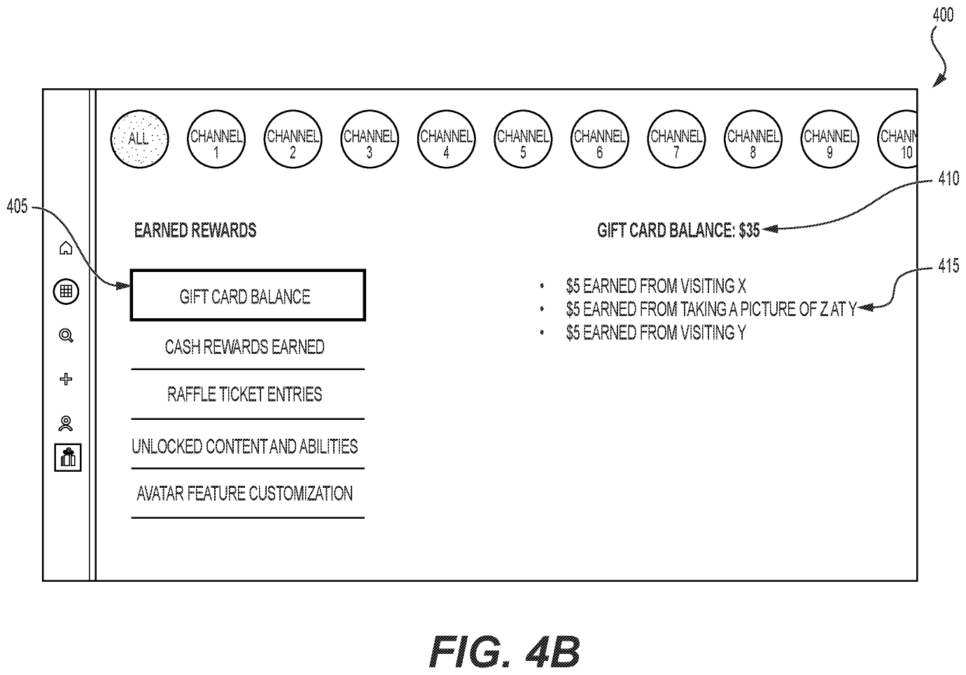

Referring now to FIG. 3, an exemplary graphical user interface 300 of a media-streaming platform is provided. In an embodiment, a user may access a listing of their obtained rewards by, for example, selecting a “rewards” icon 305 from a panel bar of the media-streaming platform. Upon selection of the rewards icon 305, the user may be presented with the graphical user interface 400 illustrated in FIG. 4A, which depicts a selectable list of earned reward types. Upon selection of one of these rewards types by the user, e.g., “Gift Card Balance” 405, as shown in FIG. 4B, information associated with that reward type may be further provided to the user, e.g., the accumulated gift card rewards balance 410 and a historical list 415 of earned gift card rewards.

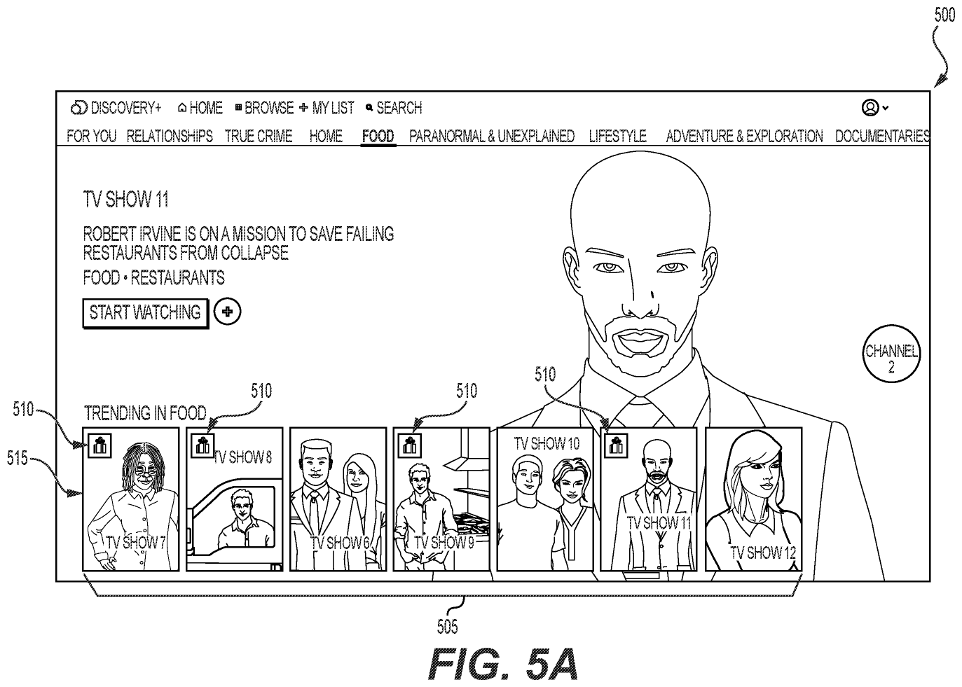

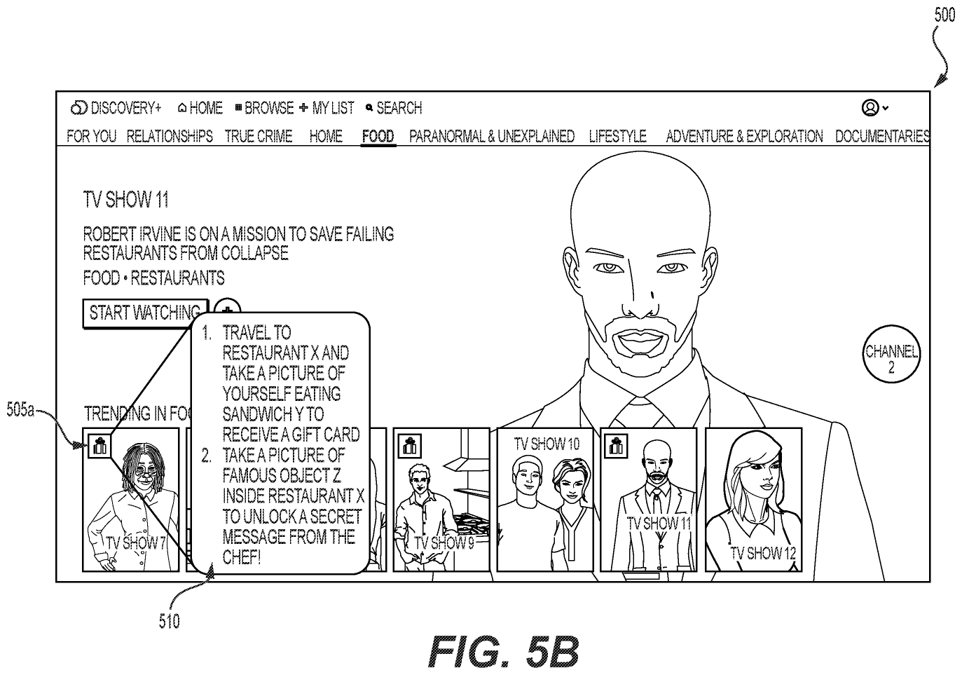

Referring now to FIG. 5A, a user may be apprised about which articles of multimedia content offer rewards in response to performance of rewards-based actions. For example, FIG. 5A depicts a graphical user interface 500 of an exemplary home screen of a media-streaming platform. The exemplary home screen may contain a content recommendation rail 505, in which a plurality of different multimedia content options are presented for selection. Those articles of multimedia content for which a reward may be obtained via performance of a rewards-based action may contain a rewards icon 510 located within the multimedia content preview pane 515 of the content recommendation rail 505. Selection (e.g., by clicking or tapping, hovering, etc.) of the rewards icon 510 in the preview pane 515 may generate a popup box 520, as illustrated in FIG. 5B. The popup box 520 may provide an indication of the available rewards-based actions that a user may perform in association with the relevant article of multimedia content along with the type of reward that is obtainable by the user subsequent to successful performance of the rewards-based action(s).

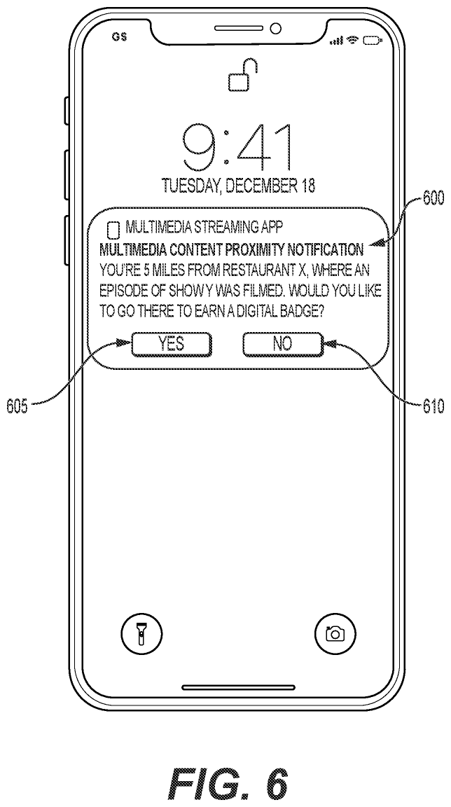

Referring now to FIG. 6, an exemplary notification 600 may be generated by the computer server 115 for display on the user computing device 105 in response to detection that a user is proximate to a rewards-based action. More particularly, in some instances, user may be traveling and may not be aware that they are physically proximate to a location that, upon visitation to, may correspond to a rewards-based action for which a reward may be obtained for. Accordingly, in an embodiment, the computer server 115 may transmit instructions to the user computing device 105 to generate a push notification 600 that alerts the user of the rewards opportunity and provides them with relevant information (e.g., what the rewards-based action is, what the reward/reward type is for performance of the rewards-based action, etc.). The notification 600 may contain a confirm selection 605 and a decline selection 610. Selection by the user of the confirm selection 605 may thereafter provide the user with additional information (e.g., directions to the predetermined location from the user's current geographic location) to aid them in performance of the rewards-based action. Conversely, selection by the user of the decline selection 610 may remove the notification 600 from the display screen of the user computing device 105.

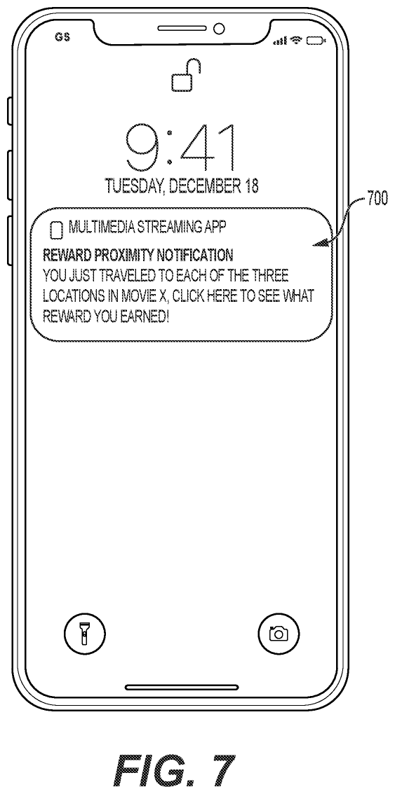

Referring now to FIG. 7, an exemplary notification 700 may be generated by the computer server 115 for display on the user computing device 105 in response to detection that a rewards-based action was completed and a corresponding reward was awarded. Such a notification may provide a confirmation indication to the user that they successfully completed the rewards-based action they were trying to perform. Additionally, in some instances, users may unknowingly complete a rewards-based action for which a reward is awarded for. In the instances, the notification 700 may inspire the user to obtain additional information into the article of multimedia content associated with the rewards-based action and/or may perhaps motivate them to intentionally complete other rewards-based actions in the future.

A variety of different types of reward types and distribution protocols, and the structures, content, and functionality associated therewith, were previously disclosed. The characteristics associated with each reward type and/or distribution protocol may be presented alone, or in combination, with the characteristics of any other foregoing reward type and/or distribution protocol. Furthermore, it should be understood that previously disclosed embodiments are exemplary only, and that other embodiments may include various combinations of features from other embodiments, as well as additional or fewer features.

In general, any process discussed in this disclosure that is understood to be computer-implementable, such as the process illustrated in FIG. 2, may be performed by one or more processors of a computer server, such as computer server 115, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer server. A processor may be a central processing unit (CPU), a graphics processing unit (GPU), or any suitable types of processing unit.

A computer system, such as computer server 115, may include one or more computing devices. If the one or more processors of the computer system are implemented as a plurality of processors, the plurality of processors may be included in a single computing device or distributed among a plurality of computing devices. If a computer server 115 comprises a plurality of computing devices, the memory of the computer server 115 may include the respective memory of each computing device of the plurality of computing devices.

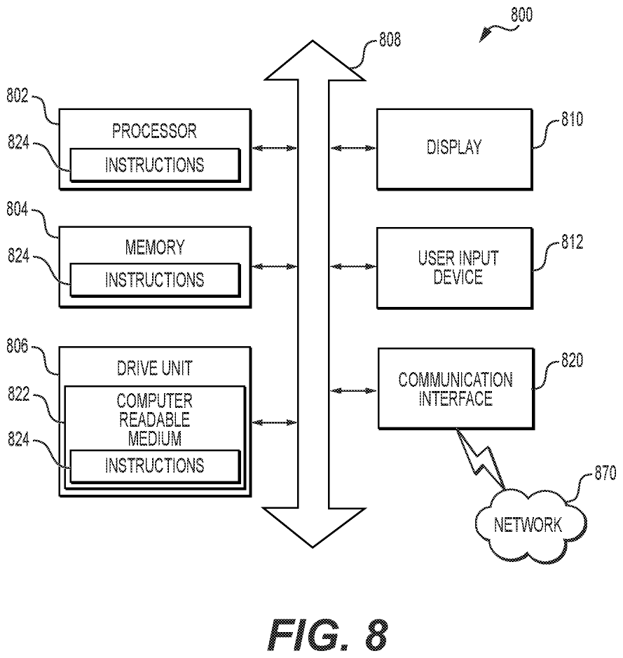

FIG. 8 is a simplified functional block diagram of a computer system 800 that may be configured as a computing device for executing the process illustrated in FIG. 2, according to exemplary embodiments of the present disclosure. FIG. 8 is a simplified functional block diagram of a computer that may be configured as the computer server 115 according to exemplary embodiments of the present disclosure. In various embodiments, any of the systems herein may be an assembly of hardware including, for example, a data communication interface 820 for packet data communication. The platform also may include a central processing unit (“CPU”) 802, in the form of one or more processors, for executing program instructions. The platform may include an internal communication bus 808, and a storage unit 806 (such as ROM, HDD, SDD, etc.) that may store data on a computer readable medium 822, although the system 800 may receive programming and data via network communications. The system 800 may also have a memory 804 (such as RAM) storing instructions 824 for executing techniques presented herein, although the instructions 824 may be stored temporarily or permanently within other modules of system 800 (e.g., processor 802 and/or computer readable medium 822). The system 800 also may include input and output ports 812 and/or a display 810 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to asynchronous consumption of streaming media, it should be appreciated that the presently disclosed embodiments may be applicable to transmitting data and may be applicable to any environment, such as a desktop or laptop computer, a gaming console environment, and any CTV (connected TV) environment (e.g., an internet-connected device used to watch multimedia content items), etc. Also, the presently disclosed embodiments may be applicable to any type of Internet protocol.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the process shown in FIG. 16, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for adjusting a characteristic of a media-streaming platform based on user actions performed in association with multimedia content, the method comprising operations including:
receiving, at a computer system and from a user computing device, an indication of a real-world action performed by a user, wherein detection of the real-world action comprises:
identifying, from location data obtained from one or more sensors resident on the user computing device, that the user computing device is moved to a new geographic location;
identifying, using one or more processors associated with the computer system, that the real-world action corresponds to a predetermined action performed in association with an article of multimedia content present on the media-streaming platform, wherein the predetermined action at least corresponds to visitation to a geographic location associated with an aspect that was featured in the article of multimedia content, wherein the article of multimedia content is a motion picture;
determining, using the one or more processors, whether performance of the predetermined action necessitates adjustment of the characteristic of the media-streaming platform, wherein the adjustment of the characteristic corresponds to modification of access to a feature associated with the media-streaming platform;
ascertaining, using the one or more processors and subsequent to determining that performance of the predetermined action does necessitate adjustment of the characteristic, a type of the feature, wherein the type of the feature is based on the motion picture that the predetermined action is performed in association with; and
modifying, using the one or more processors and based on the ascertaining, the access to the feature of the ascertained type for a user profile associated with the user on the media-streaming platform.

2. The computer-implemented method of claim 1, wherein the aspect corresponds to at least one of: a place that was featured or mentioned in the article of multimedia media content or that the article of multimedia content was filmed in or at, a structure that was featured or mentioned in the article of multimedia content, and an object that was featured or mentioned in the article of multimedia content.

3. The computer-implemented method of claim 1, wherein the determining comprises:
identifying, from a ruleset, that the characteristic is adjusted upon identification that the predetermined action is performed a predetermined number of times;
wherein performance of the predetermined action each of the predetermined number of times corresponds to visitation to a new geographic location associated with a different aspect associated with either: the article of multimedia content or another article of multimedia content present on the media-streaming platform.

4. (canceled)

5. The computer-implemented method of claim 1, wherein the type of the feature corresponds to an unlockable feature associated with the media-streaming platform and wherein the modifying comprises enabling access to the unlockable feature via the user profile;
wherein the unlockable feature is at least one of: an exclusive article of multimedia content, a digital badge, and an ability to perform an exclusive action on the media-streaming platform.

6. The computer-implemented method of claim 1, wherein the type of the feature corresponds to an entry ticket into a raffle and wherein the modifying comprises associating the entry ticket to the user profile.

7. The computer-implemented method of claim 1, wherein the type of the feature corresponds to a feature addition to a digital avatar and wherein the modifying comprises enabling, on the user profile, selection of the feature addition;
wherein the feature addition is at least one of: a digital skin, a digital clothing accessory, a digital animation, and a voice line.

8. The computer-implemented method of claim 1, wherein the predetermined action further comprises scanning a QR code present at the geographic location, and further comprising:
detecting, at the server, that the user is not associated with the media-streaming platform; and
presenting, on a screen of a user device associated with the user, an account activation option for the media-streaming platform;
wherein the modifying comprises:
providing, subsequent to detection of the account activation and on the media-streaming platform, a deferred link; and
modifying the access to the feature responsive to detecting selection of the deferred link.

9. The computer-implemented method of claim 1, wherein the ascertaining the type of the feature comprises ascertaining based upon a predetermined ruleset.

10. (canceled)

11. A system for adjusting a characteristic of a media-streaming platform based on user actions performed in association with multimedia content, the system comprising:
at least on processor;
at least one database; and
a server in network communication with the at least one database, the server configured to perform operations including:
receiving an indication of a real-world action performed by a user, wherein detection of the real-world action comprises:
identifying, from location data obtained from one or more sensors resident on the user computing device, that the user computing device is moved to a new geographic location;
identifying that the real-world action corresponds to a predetermined action performed in association with an article of multimedia content present on the media-streaming platform, wherein the predetermined action at least corresponds to visitation to a geographic location associated with an aspect that was featured in the article of multimedia content, wherein the article of multimedia content is a motion picture;
determining whether performance of the predetermined action necessitates adjustment of the characteristic of the media-streaming platform, wherein the adjustment of the characteristic corresponds to modification of access to a feature associated with the media-streaming platform;
ascertaining, subsequent to determining that performance of the predetermined action does necessitate adjustment of the characteristic, a type of the-feature, wherein the type of the feature is based on the motion picture that the predetermined action is performed in association with, and
modifying, based on the ascertaining, the access to the feature of the ascertained type for a user profile associated with the user on the media-streaming platform.

12. The system of claim 11, wherein the aspect corresponds to at least one of: a place that was featured or mentioned in the article of multimedia media content or that the article of multimedia content was filmed in or at, a structure that was featured or mentioned in the article of multimedia content, and an object that was featured or mentioned in the article of multimedia content.

13. The system of claim 11, wherein the determining comprises:
identifying, from a ruleset, that the characteristic is adjusted upon identification that the predetermined action is performed a predetermined number of times;
wherein performance of the predetermined action each of the predetermined number of times corresponds to visitation to a new geographic location associated with a different aspect associated with either: the article of multimedia content or another article of multimedia content present on the media-streaming platform.

14. (canceled)

15. The system of claim 11, wherein the type of the feature corresponds to an unlockable feature associated with the media-streaming platform and wherein the modifying comprises enabling access to the unlockable feature via the user profile;
wherein the unlockable feature is at least one of: an exclusive article of multimedia content, a digital badge, and an ability to perform an exclusive action on the media-streaming platform.

16. The system of claim 11, wherein the type of the feature corresponds to an entry ticket into a raffle and wherein the modifying comprises associating the entry ticket to the user profile.

17. The system of claim 11, wherein the type of the feature corresponds to a feature addition to a digital avatar and wherein the modifying distributing the reward comprises enabling, on the user profile, selection of the feature addition;
wherein the feature addition is at least one of: a digital skin, a digital clothing accessory, a digital animation, and a voice line.

18. The system of claim 11, wherein the predetermined action further comprises scanning a QR code present at the geographic location, and further comprising:
detecting, at the server, that the user is not associated with the media-streaming platform; and
presenting, on a screen of a user device associated with the user, an account activation option for the media-streaming platform;
wherein the modifying comprises:
providing, subsequent to detection of the account activation and on the media-streaming platform, a deferred link; and
modifying the access to the feature responsive to detecting selection of the deferred link.

19. (canceled)

20. A non-transitory computer-readable medium storing computer-executable instructions which, when executed by a server in network communication with at least one database, cause the server to perform operations comprising:
receiving, at the server, an indication of a real-world action performed by a user, wherein detection of the real-world action comprises;
identifying, from location data obtained from one or more sensors resident on the user computing device, that the user computing device is moved to a new geographic location;
identifying, using one or more processors associated with the computer system, that the real-world action corresponds to a predetermined action performed in association with an article of multimedia content present on the media-streaming platform, wherein the predetermined action at least corresponds to visitation to a geographic location associated with an aspect that was featured in the article of multimedia content, wherein the article of multimedia content is a motion picture;
determining, by the server, whether performance of the predetermined action necessitates adjustment of the characteristic of the media-streaming platform, wherein the adjustment of the characteristic corresponds to modification of access to a feature associated with the media-streaming platform;
ascertaining, subsequent to determining that performance of the predetermined action does necessitate adjustment of the characteristic, a type of the-feature, wherein the type of the feature is based on the motion picture that the predetermined action is performed in association with; and
modifying, using the one or more processors and based on the ascertaining, the access to the feature of the ascertained type for a user profile associated with the user on the media-streaming platform.
